(19) United States
(12) Patent Application Publication
(10) Pub. No.: US 2026/0313484 A1
(43) Pub. Date: Oct. 8, 2026

(54) TERMINAL APPARATUS THAT EXECUTES HANDOVER WITH IMPROVED EFFICIENCY, CONTROL METHOD, AND COMPUTER-READABLE STORAGE MEDIUM

(71) Applicant: KDDI CORPORATION, Tokyo (JP)

(72) Inventors: Yoshitaka TAKAKU, Tokyo (JP); Hiroki TAKEDA, Tokyo (JP); Yanwei LI, Tokyo (JP); Jungyeon HONG, Fujimino-shi, Saitama (JP)

(21) Appl. No.: 19/462,020

(22) Filed: Jan. 28, 2026

Related U.S. Application Data
(63) Continuation of application No. PCT/JP2024/027526, filed on Aug. 1, 2024.

(30) Foreign Application Priority Data
Aug. 8, 2023 (JP) 2023-129494

(51) Int. Cl. H04W 36/00; H04W 36/08; H04W 56/00; H04W 72/231

(52) U.S. Cl. CPC H04W 36/0072; H04W 36/08; H04W 56/0045; H04W 72/231

(57) ABSTRACT

A terminal apparatus compliant with a 3rd Generation Partnership Project cellular communication standard receives first identification information and second identification information before receiving a Cell Switch Command for instructing switching of a cell to which the terminal apparatus is connected, the first identification information identifying setting information of a cell that is a candidate cell in cell switching, and the second identification information being related to a Timing Advance value (TA value) used for the candidate cell, and in a case where the cell switching is to be performed with use of the first identification information based on reception of the Cell Switch Command, determines, based on information included in the Cell Switch Command, whether to perform uplink communication using a TA value that is based on the second identification information related to a switch destination cell.

### CROSS-REFERENCE TO RELATED APPLICATION(S)

This application is a continuation of International Patent Application No. PCT/JP2024/027526 filed on Aug. 1, 2024, which claims priority to and the benefit of Japanese Patent Application No. 2023-129494 filed on Aug. 8, 2023, the entire disclosures of which are incorporated herein by reference.

### BACKGROUND OF THE INVENTION

### Field of the Invention

The present invention relates to a handover technique in a cellular communication system.

### Description of the Related Art

In a mobile communication system, as a terminal apparatus moves, the cell (base station apparatus) that the terminal apparatus is connected to is switched (e.g., a handover). Conventionally, after the terminal apparatus has received a handover instruction from a base station apparatus, processing for establishing a connection is performed by executing establishment of synchronization and setting processing in the cell that is to be a new connection destination. This processing for switching a connection destination takes a certain amount of time, and the terminal apparatus cannot communicate user data in the time period in which this processing is executed. In contrast, according to a method described in 3GPP (registered trademark) Written Contributions, R2-2209255, a base station apparatus that is a handover source provides a terminal apparatus with communication parameters in a radio resource control (RRC) layer, which is for connection with another base station apparatus that is the handover destination, before a handover is actually performed. Then, the base station apparatus that is the handover source transmits, to the terminal apparatus, a layer 1 or layer 2 command for issuing an instruction for switching the cell at the timing at which the handover is to be performed. Upon receiving this command, the terminal apparatus executes a random-access procedure together with the base station apparatus that is the handover destination; in this way, the handover can be completed without executing setting processing in the RRC layer thereafter. Such a technique can suppress deterioration in the efficiency of communication related to a handover.

### SUMMARY OF THE INVENTION

The present invention provides a technique to further improve the communication efficiency at the time of execution of a handover.

According to one aspect of the present invention, there is provided a terminal apparatus compliant with a 3rd Generation Partnership Project (3GPP (registered trademark)) cellular communication standard, the terminal apparatus comprising: one or more processors; and one or more memories that store a computer-readable instruction for causing, when executed by the one or more processors, the one or more processors to execute a control method comprising: receiving first identification information and second identification information before receiving a Cell Switch Command for instructing switching of a cell to which the terminal apparatus is connected, the first identification information identifying setting information of a cell that is a candidate cell in cell switching, and the second identification information being related to a Timing Advance value (TA value) used for the candidate cell; and in a case where the cell switching is to be performed with use of the first identification information based on reception of the Cell Switch Command, determining, based on information included in the Cell Switch Command, whether to perform uplink communication using a TA value that is based on the second identification information related to a switch destination cell.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an exemplary configuration of a wireless communication system;

FIG. 2 is a diagram showing an exemplary hardware configuration of an apparatus;

FIG. 3 is a diagram showing an exemplary functional configuration of a base station apparatus;

FIG. 4 is a diagram showing an exemplary functional configuration of a terminal apparatus; and

FIG. 5 is a diagram showing an example of a flow of processing executed in the wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

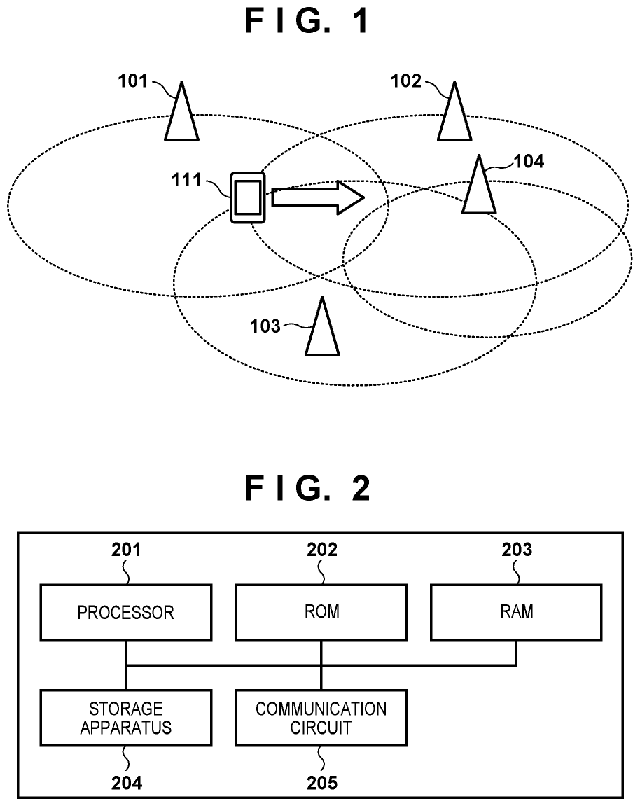

FIG. 1 shows an exemplary configuration of a wireless communication system according to the present embodiment. This wireless communication system is a cellular communication system that has been configured in conformity with a cellular communication standard, such as the fifth-generation (5G) and its successor standards of the 3rd Generation Partnership Project (3GPP (registered trademark)). The wireless communication system is configured to include base station apparatuses 101 to 104 and a terminal apparatus 111. Note that although FIG. 1 shows only four base station apparatuses and one terminal apparatus to simplify the description, a large number of base station apparatuses and terminal apparatuses can of course exist.

In FIG. 1, the terminal apparatus 111 is about to move from the inside of the range of a cell formed by the base station apparatus 101 to the inside of the range of a cell formed by the base station apparatus 102. At this time, the terminal apparatus 111 performs a handover for switching a base station apparatus that is a connection destination, from the base station apparatus 101 to the base station apparatus 102.

In the present embodiment, it is assumed that a handover procedure is executed that is intended to shorten a time period in which the terminal apparatus 111 cannot communicate user data due to a handover. That is to say, the base station apparatus 101 that is a handover source configures settings (settings that use an RRC message) in a radio resource control (RRC) layer before the terminal apparatus 111 is actually handed over. That is to say, prior to the timing at which handover processing is to be actually executed, the terminal apparatus 111 is notified of settings in the RRC layer related to the base station apparatus 102 that is a handover destination, which are, in a conventional handover, configured when the terminal apparatus 111 receives a handover instruction from the base station apparatus 101 that is the handover source and the handover processing is executed. According to the settings mentioned here, the terminal apparatus 111 is provided with a notification of communication parameters that are used in connection to and communication with the base station apparatus 102 that is a candidate for the handover destination. The communication parameters include, for example, beam settings, parameters at the time of execution of a random-access procedure, and radio resources (frequency and time resources) that are to be used in the base station apparatus 102 that is the candidate for the handover destination. Also, in a case where the notification indicates a plurality of communication parameters to be used in communication with the base station apparatus 102, an identifier (e.g., one or both of RRC-TransactionIdentifier and CondReconfigId) that is uniquely associated with each communication parameter can be included in the RRC message or RRC-layer setting parameters of which the terminal apparatus 111 is notified. In this case, CondReconfigId is set for each base station apparatus that is a candidate for the handover destination, or each combination of such base station apparatuses. Furthermore, RRC-TransactionIdentifier can be set in a case where the notification indicates a plurality of communication parameters for each base station apparatus or each combination of base station apparatuses. As an example, in a case where CondReconfigId=0 is associated with the base station apparatus 102 that is the candidate base station for the handover destination and the notification indicates a plurality of parameters of the base station apparatus 102, RRC-TransactionIdentifier (e.g., 0, 1, . . . ) can be set for each of these parameters. In addition, the base station apparatus 101 that is the handover source can transmit, to the terminal apparatus 111, a measurement instruction for synchronization signal (SS)/physical broadcast channel (PBCH) blocks (SSBs) that are transmitted from the base station apparatus 102 that is the candidate for the handover destination. Note that SSBs can be transmitted using beams that are oriented in different directions. In this case, the measurement instruction can be transmitted so that the terminal apparatus 111 measures each of these SSBs.

In accordance with the measurement instruction from the currently-connected base station apparatus 101, the terminal apparatus 111 measures SSBs transmitted from the base station apparatus 102 that is the candidate for the handover destination. Then, the terminal apparatus 111 notifies the currently-connected base station apparatus 101 of the result of this measurement. Here, the base station apparatus 101 may notify the base station apparatus 102, which is the candidate for the handover destination and is the target of measurement, of the result of this measurement. In this way, in a case where the terminal apparatus 111 has been actually handed over, the base station apparatus 102 can specify a rough direction of a beam that is to be used in communication with the terminal apparatus 111. Here, in order to further specify a precise beam that is to be used in a downlink (a link from the base station apparatus toward the terminal apparatus), the base station apparatus 102 may provide the terminal apparatus 111 with a notification of transmission settings of a channel state information (CSI)-reference signal (RS). Note that this notification is provided as a result of the base station apparatus 102 notifying the base station apparatus 101 of the transmission settings of the CSI-RS, and the base station apparatus 101 transferring the transmission settings to the currently-connected terminal apparatus 111. Upon receiving the transmission settings, the terminal apparatus 111 measures the CSI-RS transmitted from the base station apparatus 102 in accordance with information thereof, and notifies the currently-connected base station apparatus 101 of the result of the measurement. Then, the base station apparatus 101 transfers the result of the measurement to the base station apparatus 102. In this way, the base station apparatus 102 can obtain the result of the measurement of the CSI-RS in the terminal apparatus 111. As a result, before the terminal apparatus 111 is actually handed over, the base station apparatus 102 can decide a precise beam that is to be used in downlink communication after this handover. This makes it possible to skip processing for precisely deciding a beam direction after the handover has been performed, thereby shortening a time period in which the efficiency of communication of user data in the terminal apparatus 111 decreases. As an example, an instruction on the aforementioned transmission settings of the CSI-RS can be issued to the terminal apparatus 111 with use of CSI-RS measurement settings composed of radio resource settings (CSI-RS-Resource) and report settings (csi-ReportConfig) of the CSI-RS that are related to the base station apparatus 102 and are set in the terminal apparatus 111 in advance as communication parameters before the handover. The CSI-RS-Resource includes a temporal position and a frequency position of a radio resource block through which the CSI-RS is transmitted. For example, an instruction for measuring radio resources of a specific CSI-RS can be issued to the terminal apparatus 111 by specifying a CSI-RS-Resource with use of a CSI-RS-Resource id in a medium access control control element (MAC CE) or downlink control information (DCI). Also, an aperiodic or periodic report timing of a CSI report is set in the csi-ReportConfig. For example, an instruction for reporting the result of the measurement of the CSI-RS at a specific timing can be issued to the terminal apparatus 111 by specifying the csi-ReportConfig with use of a csi-ReportConfig id in the MAC CE or DCI. Also, the base station apparatus 101 can transmit, to the terminal apparatus 111, the MAC CE or DCI including, for example, a cell identifier and the like as information that is intended for the terminal apparatus 111 to specify to which base station apparatus the transmission settings of the CSI-RS are related when the aforementioned measurement settings are configured in the terminal apparatus 111.

Also, the terminal apparatus 111 executes the random-access (RA) procedure before it is decided that the handover to the base station apparatus 102 is to be executed. That is to say, the terminal apparatus 111 can be caused to execute processing for establishing synchronization in an uplink (a link from the terminal apparatus toward the base station apparatus) before the handover is actually performed. For example, the base station apparatus 101 to which the terminal apparatus 111 is currently connected transmits, to the terminal apparatus 111, an instruction for transmitting a random-access preamble (RA preamble) to the base station apparatus 102. Then, in accordance with this instruction, the terminal apparatus 111 transmits the RA preamble in radio resources that have been prepared for the RA procedure in the base station apparatus 102. Note that the base station apparatus 101 can notify the terminal apparatus 111 of information of such radio resources and a sequence used in generation of the RA preamble at the time of, for example, setting processing for the aforementioned RRC layer. Also, the terminal apparatus 111 may be notified of such information when the base station apparatus 101 issues the instruction for transmitting the RA preamble. Through this procedure, the RA preamble transmitted from the terminal apparatus 111 is received by the base station apparatus 102. Then, the base station apparatus 102 can decide a Timing Advance value (TA value) that is to be used when the terminal apparatus 111 transmits an uplink signal to the base station apparatus 102.

Thereafter, the base station apparatus 101 can provide the terminal apparatus 111 with a notification indicating that a handover is to be executed, for example, on the occurrence of a predetermined event, such as when the reception quality of radio signals from the base station apparatus 101 in the terminal apparatus 111 has deteriorated by a predetermined level compared to the reception quality of radio signals from the base station apparatus 102. This notification can be provided using a command that can be called a Cell Switch Command. This command can be transmitted using a medium access control control element (MAC CE) or downlink control information (DCI). Note that this command includes identification information of the cell formed by the base station apparatus 102 that is the handover destination. Furthermore, in a case where a plurality of settings are configured in an RRC layer used in communication with the base station apparatus 102, this command may include an identifier (e.g., one or both of RRC-TransactionIdentifier and CondReconfigId) that is uniquely associated with each of the settings in the RRC layer. Furthermore, the base station apparatus 101 may notify the terminal apparatus 111 of beam-related information which has been decided by the base station apparatus 102 and of which the base station apparatus 101 has been notified as a result of measuring SSBs and the CSI-RS in advance in the aforementioned manner. Upon receiving the command designating the base station apparatus 102 that is the handover destination from the base station apparatus 101, the terminal apparatus 111 changes the connection destination from the base station apparatus 101 to the base station apparatus 102. In this case, as the RA procedure has already been executed as described above, there is no need to newly execute the RA procedure. Furthermore, as the CSI-RS has been measured before the handover as described above, there is no need to decide a precise beam that is to be used in downlink communication after the handover again. Therefore, the terminal apparatus 111 can communicate user data with the base station apparatus 102 immediately after the handover. Moreover, in a case where the handover has succeeded after receiving the command, the terminal apparatus 111 can notify the base station apparatus 102 of this success in, for example, an RRC message of RRC Reconfiguration Complete and an uplink control message such as the MAC CE and the like. In this case, the terminal apparatus 111 may include, in the RRC message, an identifier (e.g., one or both of RRC-TransactionIdentifier and CondReconfigId) associated with a communication parameter used in communication with the base station apparatus 102.

Also, as stated earlier, the base station apparatus 102 can decide a TA value in advance. Therefore, the base station apparatus 102 can notify the base station apparatus 101 of a TA value in advance, and the base station apparatus 101 can notify the terminal apparatus 111 of this TA value with use of the aforementioned command. In this way, the terminal apparatus 111 can establish uplink synchronization with the base station apparatus 102 when the base station apparatus 101 has issued an instruction for a handover to the base station apparatus 102; therefore, the terminal apparatus 111 can transmit uplink user data to the base station apparatus 102 without executing the RA procedure again.

The terminal apparatus 111 can connect to a plurality of cells in parallel. For example, the terminal apparatus 111 can connect to the cell provided by the base station apparatus 101 and the cell provided by the base station apparatus 103 in parallel. Here, in a case where the terminal apparatus 111 connects to a plurality of cells that are respectively provided by different base station apparatuses, different TA values are set for the respective cells. For example, in the terminal apparatus 111, two TA values are set: a first TA value for the cell provided by the base station apparatus 101, and a second TA value for the cell provided by the base station apparatus 103. Note that in a case where TA values that are to be used are the same because, for example, a plurality of cells are provided by the same base station apparatus or by base station apparatuses that are substantially at the same position, the same TA value can be used with respect to these plurality of cells. A group of cells that use the same TA value in this manner is referred to as a Timing Advance group (TAG). A TA value is set for each TAG.

In the present embodiment, a case will be discussed where the terminal apparatus 111 that is currently connected to a plurality of cells is to be handed over using the aforementioned Cell Switch Command. In a case where the terminal apparatus 111 is currently connected to the plurality of cells and is to be connected to the plurality of cells also after the handover, the Cell Switch Command can include pieces of identification information of the plurality of cells after the handover. For example, in a case where the terminal apparatus 111 is to make a transition from a state where it is connected to a first cell formed by the base station apparatus 101 and a second cell formed by the base station apparatus 102, to a state where it is connected to the second cell formed by the base station apparatus 102 and a third cell formed by the base station apparatus 103, a Cell Switch Command including identification information of the second cell and identification information of the third cell can be transmitted to the terminal apparatus 111, for example. Note that in this case, the terminal apparatus 111 may be notified of the identification information of the third cell that is to be a changed connection destination, and the terminal apparatus 111 may not be notified of the identification information of the second cell. However, in this case, the terminal apparatus 111 can be notified of the identification information of the first cell that is the original connection destination. Note that although the above has described an example in which only one cell is changed among two cells, two or more cells may be changed at a time. Also, this command may include an identifier associated with settings in an RRC layer to indicate to which cell the handover is to be performed. For example, settings in one RRC layer can include a setting for using a plurality of cells in parallel. For example, in a case where a setting for connecting to the second cell formed by the base station apparatus 102 and connecting to the third cell formed by the base station apparatus 103 has been configured in advance in the terminal apparatus 111, the terminal apparatus 111 can be notified of an identifier corresponding to this setting. For example, assume that the terminal apparatus 111 that is connected to the first cell and the second cell is notified of a first setting for using the first cell and the third cell in parallel, a second setting for using the second cell and the third cell in parallel, and a third setting for using the first cell and a fourth cell formed by the base station apparatus 104 in parallel. Also assume that a first identifier, a second identifier, and a third identifier have been assigned to the first setting, the second setting, and the third setting, respectively. In this case, for example, the terminal apparatus 111 can switch the connection-destination cells to the combination of the second cell and the third cell as a result of the base station apparatus 101, which forms the first cell that is the original connection destination before the change, notifying the terminal apparatus 111 of a Cell Switch Command designating the second identifier. Note that at this time, the second base station apparatus 102, to which connection is maintained before and after the change of the connection destinations, may notify the terminal apparatus 111 of this Cell Switch Command. Also, in a case where the terminal apparatus 111 is notified in advance of setting information for using a plurality of cells in parallel, this setting information can include a TAG setting for each of the plurality of cells. For example, the setting information can include a notification indicating that the second cell and the third cell belong to a first TAG and a second TAG, respectively.

On the precondition that a plurality of cells can be switched at a time in the above-described manner, it is helpful to notify the terminal apparatus 111 of TA values that are to be respectively applied to the plurality of switch destination cells with use of this command. That is to say, as a TA value is set for each TAG as stated earlier, in a case where a plurality of cells after a handover respectively belong to different TAGs, notifying the terminal apparatus 111 of information indicating the TA values of the respective TAGs eliminates the need to again notify the terminal apparatus 111 of TA values to be used after switching the connection-destination cells. In the present embodiment, in view of the foregoing issue, a plurality of TA values can be designated in a Cell Switch Command.

In an example, a Cell Switch Command includes TA values themselves that are to be used in the respective TAGs. Also, in a case where TA values that are already held in the terminal apparatus 111 are to be used, the Cell Switch Command may include information designating the TA values held in the terminal apparatus 111, rather than the TA values themselves. For example, in a state where the terminal apparatus 111 is currently connected to the first cell formed by the base station apparatus 101 and the second cell formed by the base station apparatus 102, when the terminal apparatus 111 has switched the connection-destination cells to the second cell and the third cell formed by the base station apparatus 103, the TA value of the second cell can be reused from the TA values that were used before switching the connection destinations. Here, even in a case where the same cells are to be continuously used, there is a possibility that TAG configurations change. For this reason, the Cell Switch Command can include a notification of information indicating that a TA value that was used in a TAG to which the second cell belonged before changing the connection-destination cells is reused in a TAG to which the second cell belongs after changing the connection destinations.

Note that there is also a possibility that, as a result of executing the aforementioned RA procedure in advance with respect to the third cell to which the terminal apparatus 111 was not connected, the base station apparatus 103 decides a TA value therefor, and notifies the terminal apparatus 111 of the decided TA value in advance via the base station apparatus 101 or the base station apparatus 102. In this case, the terminal apparatus 111 may be provided with a notification indicating that this TA value, of which it has been notified in advance, is to be used with respect to a TAG to which the third cell belongs with use of the Cell Switch Command. Note that in a case where a TA value that is held in the terminal apparatus 111 in advance is to be used, this TA value is designated by identification information associated with this TA value. This identification information can be, for example, information such as information (tag-id) that designates a specific TAG before switching the connection-destination cells, and information that designates a specific cell for which the TA value is set. When notifying the terminal apparatus 111 of a TA value in advance, the base station apparatus 101 and the base station apparatus 102 connected to the terminal apparatus 111 can notify the terminal apparatus 111 of this TA value with identification information appended thereto individually. In this way, the base station apparatus 101 and the base station apparatus 102 can designate, in the Cell Switch Command, which TA value is to be used in a specific TAG after changing the connection destinations with use of this identification information.

Furthermore, although the above embodiment has been described in relation to a case where one TAG is associated with one cell, the description related to the present embodiment is also applicable to a case where a plurality of cells are associated with one TAG and one TA value is associated with each TAG, a case where different TAGs are associated respectively with a plurality of transmission and reception points (TRPs) that belong to the same cell, and a case where one cell is composed of a plurality of TRPs. In a case where one cell is composed of a plurality of TRPs, there is also a possibility that TA values are associated respectively with the TRPs. In this case, it is possible to provide, in advance, a notification of information for designating a TRP, in addition to information (tag-id) designating a TAG, as identification information that is for specifying a TA value to be used and is associated with the TA value; also, the notification may be provided using a Cell Switch Command.

Moreover, in a case where a TA value that has been set in advance and held in the terminal apparatus 111 is to be updated, the base station apparatus 101 and the base station apparatus 102 may include a difference value Ta-Tb between the value Ta after the update and the value Tb before the update in a Cell Switch Command. In this case, the terminal apparatus 111 can be notified of the Cell Switch Command that includes identification information indicating which one of the TA values that have been set in advance is to be used, and this difference value. The terminal apparatus 111 can specify a TA value that is to be used after changing the connection-destination cells by adding this difference value to a TA value corresponding to identification information for a specific TAG.

Note that methods of providing the aforementioned notification of information indicating a TA value may be used in combination. That is to say, a notification of a TA value itself may be provided with respect to some (a part) of a plurality of TAGs that are set after changing the connection destinations, whereas a notification of identification information that is associated with a specific TA value in advance (identification information of a TAG, identification information of the TA value, cell identification information, or the like) may be provided with respect to the rest of the plurality of TAGs (other parts of the plurality of TAGs).

Also, a notification of the difference value for the update may be provided with respect to only a part of TA values. That is to say, the terminal apparatus 111 may be notified of an arbitrary combination of pieces of information indicating the aforementioned TA values.

Upon receiving the Cell Switch Command in the above-described manner, the terminal apparatus 111 can specify TA values corresponding to the respective TAGs based on information indicating TA values included in this command. Then, the terminal apparatus 111 changes the connection-destination cells in accordance with this command, and adjusts transmission timings of uplink signals in cells that belong to the respective TAGs with use of the specified TA values after changing the connection-destination cells. Note that in a case where a TA value has been obtained in advance with respect to a specific cell in the above-described manner, the terminal apparatus 111 can store this TA value and specific identification information (identification information of this cell and identification information that has been prepared for the TA value) in association with each other. Then, in a case where the Cell Switch Command includes identification information as information indicating a TA value related to a specific TAG, the terminal apparatus 111 can specify the TA value corresponding to this identification information as the TA value related to this specific TAG. Also, in a case where the Cell Switch Command includes the TA value itself as information indicating the TA value related to the specific TAG, the terminal apparatus 111 can decide that the value designated in the command is to be used as the TA value related to this specific TAG. Note that in a case where the terminal apparatus 111 has received a TA value itself, it can activate a timer related to a term of validity of this TA value (timeAlignmentTimer). This timer measures a time period in which timing synchronization in transmission of uplink signals is deemed to be established by the terminal apparatus 111. The terminal apparatus 111 obtains a value unique to the terminal apparatus 111 (timeAlignmentTimerDedicated) or a value common to terminal apparatuses inside a cell (timeAlignmentTimerCommon) as an expiration time period of the timer, and manages TA values based on this value. It is permissible to provide a notification of the value of the timer related to the term of validity of the TA value (timeAlignmentTimer), together with a TAG, as a part of settings in an RRC layer that are set in advance in the terminal apparatus 111 before the notification of the Cell Switch Command is provided, and it is also permissible to set the timer value in the Cell Switch Command together with the TAG. Note that in a case where the terminal apparatus 111 is provided with a notification of TA values of candidate cells after changing the connection destinations as a result of the terminal apparatus 111 executing the RA procedure in advance before changing the connection-destination cells, base station apparatuses to which the terminal apparatus 111 is currently connected can provide, together with this notification, a notification of information of terms of validity of timers therefor. Note that in a case where the terminal apparatus 111 has received a new TA value, it reactivates a timer therefor. Upon expiration of a timer related to the aforementioned term of validity, which is managed for each TAG, the terminal apparatus 111 keeps holding a TA value that has been saved in association with a TAG related to this expired timer, and stops transmission of uplink signals that use this TA value, such as transmission of a PUCCH and an SRS. Thereafter, the terminal apparatus 111 updates the TA value in a case where it has received a TA value, or a difference value from a held TA value, from a base station apparatus. Also, in a case where a base station apparatus has issued an instruction for deleting a TA value, the terminal apparatus 111 deletes this TA value.

Note that although the above embodiment has been described in relation to a notification of TA values related to cells that are to be new connection destinations in a Cell Switch Command, this command may include a notification of a TA value related to a cell to which the terminal apparatus 111 is not connected. For example, a TA value related to the fourth cell formed by the base station apparatus 104 may be included in a Cell Switch Command for issuing an instruction for changing the connection-destination cells of the terminal apparatus 111 so as to make a transition from a state where the terminal apparatus 111 is currently connected to the first cell formed by the base station apparatus 101 and the second cell formed by the base station apparatus 102, to a state where it is connected to the second cell and the third cell formed by the base station apparatus 103. Note that in this case, it is required that the terminal apparatus 111 has executed the RA procedure for the fourth cell in advance, at least one of the base station apparatus 101 and the base station apparatus 102 has been notified of the TA value decided by the base station apparatus 104, and the terminal apparatus 111 has been notified of information of a cell managed as a cell to which the terminal apparatus 111 is not connected after a handover, as well as a TAG to which this cell belongs, in prior settings in an RRC layer before a notification of the Cell Switch Command is provided. Furthermore, at this time, the terminal apparatus 111 may be notified of information for identifying the cell managed as the cell to which the terminal apparatus 111 is not connected, as well as the TAG to which this cell belongs, in the Cell Switch Command, rather than in the prior settings in the RRC layer. By thus notifying the terminal apparatus 111 of a TA value related to a cell that is not directly involved in the change of connection destinations, timing synchronization in an uplink to the fourth base station apparatus can be established without the terminal apparatus 111 executing the RA procedure again in a case where the terminal apparatus 111 is to connect to the fourth cell due to a further change in the connection-destination cells thereof. Although the above description has been provided in connection with the fourth cell, similar processing can be executed for a plurality of cells, such as a fifth cell and a sixth cell to which the terminal apparatus 111 is not connected after the terminal apparatus 111 has changed the connection-destination cells.

### Apparatus Configuration

Next, an apparatus configuration will be described. FIG. 2 shows an exemplary hardware configuration of a base station apparatus and a terminal apparatus of the present embodiment. In an example, the base station apparatus and the terminal apparatus are configured to include a processor 201, a ROM 202, a RAM 203, a storage apparatus 204, and a communication circuit 205. The processor 201 is a computer configured to include one or more processing circuits, such as a general-purpose central processing unit (CPU) and an application-specific integrated circuit (ASIC), and executes overall processing of the apparatus and the above-described processing by reading out and executing programs stored in the ROM 202 and the storage apparatus 204. The ROM 202 is a read-only memory that stores programs related to processing executed by the base station apparatus and the terminal apparatus, and information of various types of parameters and the like. The RAM 203 is a random-access memory which functions as a working space when the processor 201 executes programs, and which stores temporary information. The storage apparatus 204 is composed of, for example, an attachable and removable external storage apparatus or the like. The communication circuit 205 is composed of, for example, a circuit for wireless communication pursuant to 5G or its successor standards. Note that although one communication circuit 205 is illustrated in FIG. 2, the base station apparatus and the terminal apparatus can include a plurality of communication circuits. For example, the base station apparatus and the terminal apparatus can include wireless communication circuits that are respectively intended for 5G and its successor standards, and an antenna that is common to these circuits. Note that the base station apparatus and the terminal apparatus may include separate antennas that are suitable for the respective standards. Also, the base station apparatus can further include a wired communication circuit that is used when communicating with other base station apparatuses and nodes of a core network. Moreover, the terminal apparatus may further include, for example, a communication circuit compliant with a wireless communication standard other than a cellular communication standard, such as a wireless local area network (LAN) and Bluetooth (registered trademark). Note that the base station apparatus and the terminal apparatus may include separate communication circuits 205 for a plurality of usable frequency bands, respectively, or may include a communication circuit 205 that is common to at least a part of these frequency bands.

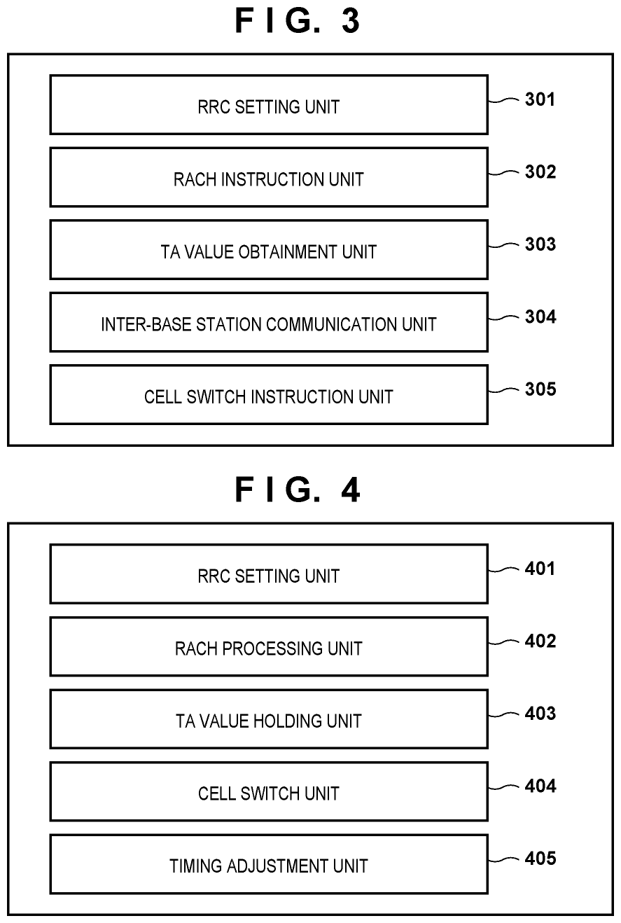

FIG. 3 shows an exemplary functional configuration of a base station apparatus. The base station apparatus includes, for example, an RRC setting unit 301, an RA instruction unit 302, a TA value obtainment unit 303, an inter-base station communication unit 304, and a cell switch instruction unit 305. Note that FIG. 3 mainly shows functions of the base station apparatus 101 or the base station apparatus 102 to which the terminal apparatus 111 is currently connected. The base station apparatus 103 and the base station apparatus 104, which form candidate cells to be new connection destinations, are similar to conventional base station apparatuses except that they transmit information related to TA values to the base station apparatus 101 and the base station apparatus 102, and therefore illustration thereof is omitted here. Note that the base station apparatus 101 to the base station apparatus 104 are categorized only based on whether they are connection destinations of the terminal apparatus 111, and all of these base station apparatuses can have the functions of FIG. 3. That is to say, for example, in a case where the base station apparatus 103 and the base station apparatus 104 are currently connected to another non-illustrated terminal apparatus, they can execute the above-described processing with use of the functions of FIG. 3 while considering the base station apparatus 101, the base station apparatus 102, and the like as candidates for new connection destinations. Note that FIG. 3 only shows functions that are particularly related to the present embodiment, and illustration of other various types of functions that can be included in the base station apparatus is omitted. For example, the base station apparatus naturally includes other functions that are generally included in a base station apparatus compliant with 5G, its successor standards, or the like. Also, the functional blocks of FIG. 3 are schematically shown, and the functional blocks may be realized in an integrated manner, or may be further segmentalized. Furthermore, each function of FIG. 3 may be, for example, realized by the processor 201 executing programs stored in the ROM 202 or the storage apparatus 204, or may be realized by a processor that is present inside, for example, the communication circuit 205 executing predetermined software. The following does not describe the details of processing executed by each functional unit, and provides an outline of only general functions thereof.

The RRC setting unit 301 configures, for example, settings in an RRC layer with respect to a currently-connected terminal apparatus. For example, the RRC setting unit 301 transmits a handover request to other base station apparatuses providing neighboring cells that are candidates for new connection destinations of the terminal apparatus, obtains communication setting information from these other base station apparatuses, and notifies the terminal apparatus of this communication setting information via a message of the RRC layer. Here, the RRC setting unit 301 can include, in the message of the RRC layer, setting information related to a combination of cells that can be used in parallel by the terminal apparatus based on, for example, information of frequency bands that can be used in parallel by the terminal apparatus, and transmit the message to the terminal apparatus. This setting information can include, for example, information indicating to which TAG each of the plurality of cells to be combined belongs. Here, in a case where the terminal apparatus is to change connection destinations, candidates for the connection destinations can include currently-connected cells. That is to say, in a state where the terminal apparatus is connected to the first cell and the second cell, if a combination of the second cell and the third cell is set as a combination of cells that are candidates for connection destinations of the terminal apparatus, the candidates for connection destinations include the currently-connected second cell. Therefore, the RRC setting unit 301 can also obtain setting information related to this second cell, and notify the terminal apparatus of the same. Note that this is an example, and the terminal apparatus may be notified only of the fact that the current setting information is to be used as setting information unique to the second cell, as well as setting information that is necessary when using the combination of the second cell and the third cell. Note that in a case where there are a plurality of candidates for a combination of connection-destination cells, when pieces of setting information are prepared for the plurality of candidates, respectively, specific pieces of identification information can be appended to the plurality of pieces of setting information, respectively. This identification information can be, for example, one or both of RRC-TransactionIdentifier and CondReconfigId. Note that the message of the RRC layer is an RRC Reconfiguration message. Thereafter, the RRC setting unit 301 configures connection processing settings between the terminal apparatus and other base station apparatuses by receiving an RRC Reconfiguration Complete message, which includes one or both of RRC-TransactionIdentifier and CondReconfigId, from the terminal apparatus.

The RA instruction unit 302 instructs the terminal apparatus in which settings of the RRC layer have been completed to transmit RA preambles for the respective cells that are candidates for connection destinations. Here, the instruction for transmitting the RA preambles includes information for specifying the base station apparatuses or cells that are transmission destinations of the RA preambles, as well as a sequence for generation of the RA preambles unique to the terminal apparatus and a group of sequences that can be used also by other terminal apparatuses that are attempting to connect to the cells that are candidates for connection destinations, and can further include information of radio resources used in transmission of the RA preambles. The RA instruction unit 302 can instruct a currently-connected terminal apparatus to transmit RA preambles to base station apparatuses that are candidates for connection destinations with use of, for example, a physical downlink control channel (PDCCH) order. Also, in a case where the RA instruction unit 302 is configured to instruct the terminal apparatus to retransmit the RA preambles or to transmit the RA preamble repeatedly as necessary, it can transmit an instruction for stopping transmission of the RA preambles to the terminal apparatus. In a case where a base station apparatus or a cell that is a transmission destination of an RA preamble is composed of a plurality of transmission and reception points (TRPs), a transmission instruction may include information for specifying a transmission-destination TRP, in addition to information for specifying the base station apparatus or the cell that is the transmission destination of the RA preamble.

For each of cells that are candidates for connection destinations of the terminal apparatus, the TA value obtainment unit 303 obtains, for example, a TA value that has been decided as a result of the RA instruction unit 302 causing the terminal apparatus to transmit an RA preamble. Furthermore, the TA value obtainment unit 303 may obtain not only TA values related to cells that are not currently connected to the terminal apparatus and are candidates for connection destinations, but also TA values related to cells included as cells that are candidate cells after changing the connection destinations among cells that are currently connected to the terminal apparatus. Note that the TA value obtainment unit 303 may not obtain TA values related to cells to which the terminal apparatus is currently connected among the candidate cells. The inter-base station communication unit 304 performs communication with base station apparatuses that form cells that are candidates for connection destinations. The inter-base station communication unit 304 can, for example, provide other base station apparatuses that are transmission destinations of RA preambles with a notification indicating that the currently-connected terminal apparatus is to transmit the RA preambles. Also, the inter-base station communication unit 304 is used in, for example, receiving information for the RA procedure in the base station apparatuses that form cells that are candidates for connection destinations from these base station apparatuses. Note that the TA value obtainment unit 303 can obtain, for example, TA values calculated in the base station apparatuses that form candidate cells via the inter-base station communication unit 304.

The cell switch instruction unit 305 instructs the terminal apparatus to execute a cell switch upon entering a state where the terminal apparatus is to execute the cell switch, such as a case where the reception quality of radio signals from another base station apparatus that forms a cell that is a candidate for connection destinations in the terminal apparatus has become higher, by a predetermined level or more, than the radio quality between the self-apparatus and the terminal apparatus, for example. The cell switch instruction unit 305 transmits, to the terminal apparatus, a Cell Switch Command including, for example, cell identifiers that can specify connection-destination cells, identification information such as RRC-TransactionIdentifier and CondReconfigId corresponding to a notification of setting information provided by the RRC setting unit 301, and the like. Note that in a case where the terminal apparatus is connected to a plurality of cells and a plurality of TAGs have been set for these plurality of cells, the cell switch instruction unit 305 can transmit, to the terminal apparatus, a command including information indicating TA values that are respectively related to the plurality of TAGs. That is to say, information indicating a first TA value to be applied to a first cell and a second TA value to be applied to a second cell among the plurality of cells can be included in this command and transmitted to the terminal apparatus. Consequently, the terminal apparatus can transmit uplink user data signals with use of each of these TA values immediately after the cell switch in the plurality of switch destination cells. Note that such information indicating the TA values may be the TA values themselves, or may be identification information (e.g., tag-id, cell identifier, and the like) that can specify the TA values held in the terminal apparatus. Furthermore, information indicating a part of the TA values among the plurality of TA values may be TA values themselves, and information indicating other TA values may be identification information that can specify these TA values. Furthermore, the cell switch instruction unit 305 may notify the terminal apparatus, via this command, of TA values for candidate cells following a further cell switch after the terminal apparatus has switched connection destinations. This eliminates the need to execute the RA procedure again with respect to candidate cells in a case where the terminal apparatus is to further switch connection-destination cells. Note that when notifying the terminal apparatus of TA values themselves, the cell switch instruction unit 305 can notify the terminal apparatus, via the Cell Switch Command, of values of timeAlignmentTimerCommon or timeAlignmentTimerDedicated related to these TA values.

FIG. 4 shows an exemplary functional configuration of a terminal apparatus. The terminal apparatus includes, for example, an RRC setting unit 401, an RA processing unit 402, a TA value holding unit 403, a cell switch unit 404, and a timing adjustment unit 405. Note that FIG. 4 only shows functions that are particularly related to the present embodiment, and illustration of other various types of functions that can be included in the terminal apparatus is omitted. For example, the terminal apparatus naturally includes other functions that are generally included in a terminal apparatus compliant with 5G, its successor standards, or the like. Also, the functional blocks of FIG. 4 are schematically shown, and the functional blocks may be realized in an integrated manner, or may be further segmentalized. Furthermore, each function of FIG. 4 may be, for example, realized by the processor 201 executing programs stored in the ROM 202 or the storage apparatus 204, or may be realized by a processor that is present inside, for example, the communication circuit 205 executing predetermined software. Note that regarding the details of processing executed by each functional unit, the following does not describe the aforementioned details, and provides an outline of only general functions thereof.

The RRC setting unit 401 executes connection setting processing with respect to cells that are candidates for connection destinations by receiving a message of an RRC layer from a base station apparatus that is a connection destination. Note that the RRC setting unit 401 holds settings related to currently-connected cells and settings related to cells that are candidates for connection destinations in parallel. Also, in a case where a plurality of pieces of setting information are held, the RRC setting unit 401 can hold corresponding identification information (e.g., one or both of RRC-TransactionIdentifier and CondReconfigId) together with such pieces of setting information. Note that setting information related to a combination of a plurality of cells can include, for example, information indicating to which TAG each of these plurality of cells belongs. Upon receiving an instruction for transmitting RA preambles from the currently-connected base station apparatus, the RA processing unit 402 transmits RA preambles for cells that are candidates for connection destinations. Here, information of a sequence for generating the RA preambles and radio resources for reception of the RA preambles in cells that are candidates for connection destinations can be received from the currently-connected base station apparatus. Note that such information of the sequence and the radio resources may be obtained from system information transmitted by base station apparatuses that form cells that are candidates for connection destinations. Note that after the transmission of the aforementioned RA preambles, the RA processing unit 402 can, for example, obtain TA values that have been decided in the base station apparatuses that are transmission destinations of these TA values via the currently-connected base station apparatus. Also, at this time, in a case where there are a plurality of cells that are candidates for connection destinations and that can use the same TA value, the RA processing unit 402 may receive information for specifying the cells that can use the same TA value from the base station apparatus, and save this TA value in association with information for identifying a TAG, such as tag-id.

The TA value holding unit 403 holds, for example, TA values for adjusting transmission timings of uplink signals to the currently-connected base station apparatus, and TA values obtained by the RA processing unit 402 or notified via the Cell Switch Command from the currently-connected base station apparatus. The TA value holding unit 403 can hold TA values in association with, for example, pieces of identification information of TAGs to which these TA values are applied, or pieces of identification information of cells to which these TA values are applied (cells formed by base station apparatuses that have decided these TA values). Note that in a case where a difference value between a post-update TA value and a pre-update TA value has been notified together with identification information associated with a specific TA value for the purpose of updating the specific TA value, the TA value holding unit 403 can update the TA value corresponding to this identification information with use of the notified difference value. Furthermore, the TA value holding unit 403 can activate a timer (timeAlignmentTimer) when a TA value has been obtained. This TA value is handled as a valid TA value until the timer expires.

The cell switch unit 404 changes connection-destination cells in response to reception of a command (Cell Switch Command) for issuing an instruction for switching cells from the currently-connected base station apparatus. This command can include identification information designating which is to be used among pieces of setting information that have been set in the RRC setting unit 401. The terminal apparatus can specify to which cells it is to connect by extracting the identification information from the command and specifying pieces of setting information corresponding to this identification information. Note that this is an example, and cell identification information that designates connection-destination cells may be included in the command. Furthermore, the command includes information indicating TA values that are to be used. Note that in a case where the terminal apparatus connects to a plurality of cells, the command can include information indicating a first TA value for a first cell and information indicating a second TA value for a second cell included in the plurality of cells. That is to say, the command can include information indicating a plurality of TA values. Note that the information indicating the TA values may be the TA values themselves, or may be identification information that can specify the TA values.

The timing adjustment unit 405 adjusts transmission timings of uplink signals based on, for example, TA values held in the TA value holding unit 403.

Also, in a case where connection-destination cells are to be switched via a Cell Switch Command, the timing adjustment unit 405 adjusts transmission timings of uplink signals after the cell switch based on a notification of information indicating TA values provided by this command. In this way, TA values that are to be used are specified based on information included in the Cell Switch Command, and thus the terminal apparatus can transmit uplink signals at an appropriate timing immediately after switching connection-destination cells.

### Flow of Processing

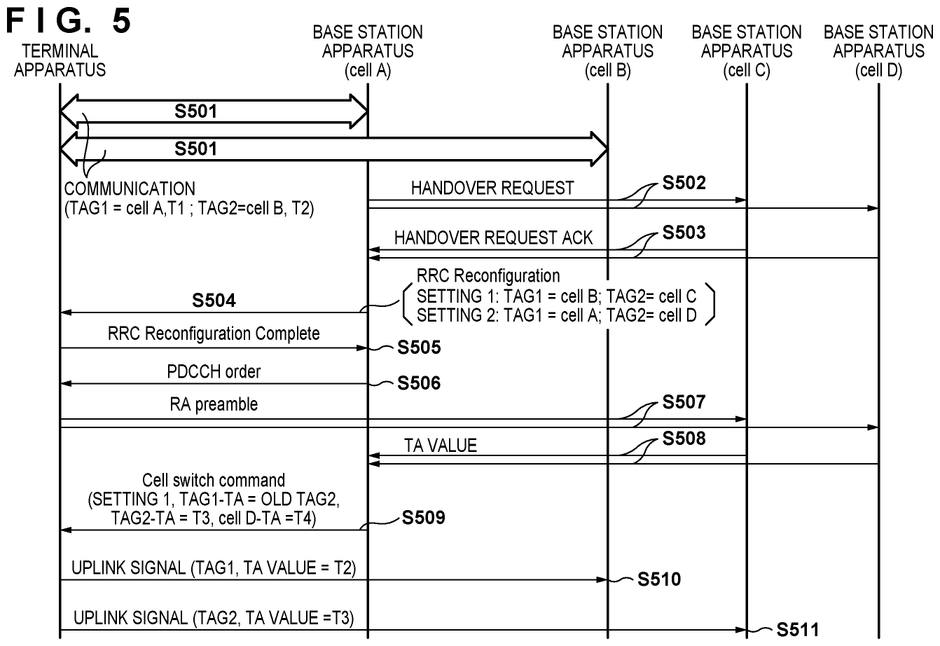

Next, an example of a flow of processing executed in the wireless communication system will be described using FIG. 5. Note that the flow of processing of FIG. 5 is an example, and the above-described modifications can be made in each procedure.

In the present processing example, for example, it is assumed that the terminal apparatus has initially established connection to a base station apparatus that provides a cell A and a base station apparatus that provides a cell B, and is performing communication in these cells (step S501). Here, it is assumed that the cell A belongs to TAG1, the cell B belongs to TAG2, T1 is used as a TA value in TAG1, and T2 is used as a TA value in TAG2. That is to say, the terminal apparatus controls a transmission timing of an uplink signal to the cell A so that it is faster by T1 than a timing at which this signal is received, and controls a transmission timing of an uplink signal to the cell B so that it is faster by T2 than a timing at which this signal is received. Thereafter, for example, the base station apparatus that forms the cell A first transmits a HANDOVER REQUEST message to base station apparatuses that respectively form a cell C and a cell D that are candidates for connection destinations after the terminal apparatus has switched cells (step S502). Upon receiving this message, the base station apparatus that forms the cell C or the cell D returns, to the base station apparatus that forms the cell A, a HANDOVER REQUEST ACK message including setting information, such as information of communication parameters that are to be used when the terminal apparatus connects thereto (step S503). Note that the base station apparatus that forms the cell A can hold, in advance, setting information for the cell B to which the terminal apparatus is already connected, for example. Then, the base station apparatus that forms the cell A notifies the terminal apparatus of an RRC Reconfiguration message including the setting information, such as the communication parameters, of which it has been notified by other base station apparatuses (step S504). The setting information notified here can include setting information for using a plurality of cells in parallel. Also, identification information that can specify this setting information can be associated with this setting information. It is assumed here that the terminal apparatus is notified of a setting 1 for using the cell B and the cell C in parallel, and a setting 2 for using the cell A and the cell D in parallel. Also, the terminal apparatus is notified of information indicating that the cell B belongs to TAG1 and the cell C belongs to TAG2 under the setting 1, the cell A belongs to TAG1 and the cell D belongs to TAG2 under the setting 2, and the like. Upon receiving this message, the terminal apparatus transmits an RRC Reconfiguration Complete message to the base station apparatus of the cell A, and completes setting processing that uses the message of the RRC layer (step S505). Through this processing, the terminal apparatus no longer needs to execute setting processing for the RRC layer after it has been instructed to switch cells.

Next, the base station apparatus of the cell A instructs the terminal apparatus to transmit an RA preamble to each of cells that are candidates for connection destinations after the cell switch (step S506). Here, this instruction can include a sequence that is to be used by the terminal apparatus in generating the RA preambles, and information designating radio resources through which these RA preambles are to be transmitted. Note that the radio resources through which the RA preambles are to be transmitted may be specified based on, for example, system information of the cells that are candidates for connection destinations, which is transmitted in these cells and measured by the terminal apparatus. That is to say, the terminal apparatus may not obtain this information from the currently-connected base station apparatuses. Also, the sequence that is to be used in generating the RA preambles may be specified in advance. In an example, the terminal apparatus may be notified of information of this sequence in step S504. The terminal apparatus transmits the RA preambles to the unconnected cells C and D in accordance with the instruction (step S507). At this time, the base station apparatus of the cell A may provide the base station apparatus of the cell C and the base station apparatus of the cell D with a notification indicating that the terminal apparatus is scheduled to transmit the RA preambles. At this time, the base station apparatus of the cell A can notify the base station apparatus of the cell C and the base station apparatus of the cell D of the information of the sequence used in generation of the RA preambles that are transmitted by the terminal apparatus to the respective cells. In this way, the base station apparatus of the cell C and the base station apparatus of the cell D can detect the RA preambles transmitted by the terminal apparatus. Note that this is an example; for example, the HANDOVER REQUEST of step S502 may implicitly provide a notification indicating that the terminal apparatus is scheduled to transmit the RA preambles. Also, in this case, the HANDOVER REQUEST ACK of step S503 may designate the sequence that is to be used by the terminal apparatus in generating the RA preambles. Note that these are examples; the base station apparatus of the cell A, the base station apparatus of the cell C, and the base station apparatus of the cell D may share, for example, the information of the sequence that is to be used by the terminal apparatus in generating the RA preambles with use of another message. The base station apparatus of the cell C and the base station apparatus of the cell D can calculate TA values based on the RA preambles transmitted from the terminal apparatus, and notify the base station apparatus of the cell A of the calculated TA values (step S508).

Thereafter, cell switch processing can be executed, for example, in a case where a predetermined condition has been satisfied, such as when the radio quality of signals from the base station apparatus of the cell C has become higher, by a predetermined level or more, than the radio quality of signals from the base station apparatus of the cell A in the terminal apparatus. It is assumed that the base station apparatus of the cell A has decided that the connection-destination cells of the terminal apparatus are to be changed, for example, from a combination of the cell A and the cell B to a combination of the cell B and the cell C. In this case, the terminal apparatus has been notified of a setting for using the cell B and the cell C in combination as the “setting 1” in step S504. Therefore, the base station apparatus of the cell A transmits, to the terminal apparatus, a Cell Switch Command for issuing an instruction for switching the connection-destination cells with use of the “setting 1” (step S509). Note that this is an example; with use of this command, the terminal apparatus can be notified of arbitrary information that enables the terminal apparatus to specify that the cell B and the cell C are to be used in combination. Note that this command includes information indicating TA values. Here, the setting 1 notified in step S504 designates that the cell B and the cell C belong to TAG1 and TAG2, respectively. Therefore, the command includes a plurality of TA values that are to be used in the respective TAGs. For example, as the terminal apparatus was connected to the cell B even before switching the connection-destination cells and the cell B belonged to TAG2 at that time, it is expected that the TA value that was used in TAG2 before the cell switch can be used in TAG1 after the cell switch. Therefore, the Cell Switch Command can include information (e.g., tag-id) designating the TA value of TAG2 before the cell switch as information indicating the TA value of TAG1 to which the cell B belongs. Furthermore, before the cell switch, the terminal apparatus is not connected to the cell C, and has not been notified of the TA value related to this cell C. Therefore, the Cell Switch Command can include “T3”, which is the TA value that is to be used in this cell C, as information indicating the TA value of TAG2 to which the cell C belongs. As the base station apparatus of the cell C has notified the base station apparatus of the cell A of this TA value in step S508, the base station apparatus of the cell A can include this TA value (T3) in the Cell Switch Command.

Upon receiving the Cell Switch Command, the terminal apparatus changes the connection-destination cells to the combination of the cell B and the cell C in accordance with this command. Then, the terminal apparatus can specify TA values that are to be used in the respective cells with use of information indicating the TA values that is included in this command. Therefore, the terminal apparatus can transmit uplink signals at transmission timings that have been appropriately adjusted immediately after the cell switch, without being notified of the TA values again by the base station apparatus of the cell C and the like (steps S510 and S511).

Note that although the present processing example has been described using an example in which the base station apparatus that forms the cell A plays a lead role in control of the cell switch and the like, the base station apparatus that forms the cell B to which the terminal apparatus is connected may play a lead role in this control. Furthermore, the example of FIG. 5 represents an example in which the terminal apparatus is notified of the TA value for the cell D, which has already been obtained in the cell A, with use of the Cell Switch Command. In this way, the terminal apparatus no longer needs to execute the RA procedure again in a case where a connection-destination cell is further switched to the cell D after the connection-destination cells are changed to the cell B and the cell C. However, this is an example, and the Cell Switch Command may not include the TA value for the cell D. Moreover, although the aforementioned example represents an example in which the Cell Switch Command includes a notification of the TA value for the cell C, the base station apparatus of the cell A may notify the terminal apparatus of this TA value (T3) and specific identification information, such as identification information of the cell C, in association with each other after step S508, for example. In this case, the terminal apparatus holds this specific identification information and the TA value of which it has been notified. Then, this specific identification information is included in the Cell Switch Command of step S509 as information indicating the TA value of TAG2; this enables the terminal apparatus to specify that the TA value (T3), which is held in association with this specific identification information, is to be used in this TAG2. Note that although the above description has been provided in relation to a case where TAG1 and TAG2 are used, two or more TAGS, such as TAG3, TAG4, and TAGn, may be used.

As described above, the present embodiment can significantly shorten a time period from when a base station apparatus that is a connection destination before changing a cell has decided to change the connection destination of a terminal apparatus to another cell, to when this terminal apparatus starts transmission of uplink signals including user data in a cell after the change. This makes it possible to contribute to Goal 9 of Sustainable Development Goals (SDGs) led by the United Nations, which is to “build resilient infrastructure, promote inclusive and sustainable industrialization, and foster innovation”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A terminal apparatus compliant with a 3rd Generation Partnership Project (3GPP (registered trademark)) cellular communication standard, the terminal apparatus comprising:
one or more processors; and
one or more memories that store a computer-readable instruction for causing, when executed by the one or more processors, the one or more processors to execute a control method comprising:
receiving first identification information and second identification information before receiving a Cell Switch Command for instructing switching of a cell to which the terminal apparatus is connected, the first identification information identifying setting information of a cell that is a candidate cell in cell switching, and the second identification information being related to a Timing Advance value (TA value) used for the candidate cell; and
in a case where the cell switching is to be performed with use of the first identification information based on reception of the Cell Switch Command, determining, based on information included in the Cell Switch Command, whether to perform uplink communication using a TA value that is based on the second identification information related to a switch destination cell,
wherein based on a value indicating a TA value not being included in the Cell Switch Command, the terminal apparatus determines that uplink communication is to be performed using the TA value that is based on the second identification information.

2. The terminal apparatus according to claim 1, wherein
the terminal apparatus receives the first identification information and the second identification information through RRC Reconfiguration.

3. The terminal apparatus according to claim 1, wherein
the control method further comprises, in a case where third identification information is received through the Cell Switch Command, performing the cell switching using a cell specified by third identification information as the switch destination cell.

4-5. (canceled)

6. A control method executed by a terminal apparatus compliant with a 3rd Generation Partnership Project (3GPP (registered trademark)) cellular communication standard, the method comprising:
receiving first identification information and second identification information before receiving a Cell Switch Command for instructing switching of a cell to which the terminal apparatus is connected, the first identification information identifying setting information of a cell that is a candidate cell in cell switching, and the second identification information being related to a Timing Advance value (TA value) used for the candidate cell; and
in a case where the cell switching is to be performed with use of the first identification information based on reception of the Cell Switch Command, determining, based on information included in the Cell Switch Command, whether to perform uplink communication using a TA value that is based on the second identification information related to a switch destination cell,
wherein based on a value indicating a TA value not being included in the Cell Switch Command, the terminal apparatus determines that uplink communication is to be performed using the TA value that is based on the second identification information.

7. (canceled)

8. A terminal apparatus compliant with a 3rd Generation Partnership Project (3GPP (registered trademark)) cellular communication standard, the terminal apparatus comprising:
one or more processors; and
one or more memories that store a computer-readable instruction for causing, when executed by the one or more processors, the one or more processors to execute a control method comprising:
receiving first identification information and second identification information before receiving a Cell Switch Command for instructing switching of a cell to which the terminal apparatus is connected, the first identification information identifying setting information of a cell that is a candidate cell in cell switching, and the second identification information being related to a Timing Advance value (TA value) used for the candidate cell; and
in a case where the cell switching is to be performed with use of the first identification information based on reception of the Cell Switch Command, determining, based on information included in the Cell Switch Command, whether to perform uplink communication using a TA value that is based on the second identification information related to a switch destination cell,
in a case where a value indicating a TA value is included in the Cell Switch Command, the terminal apparatus determines that uplink communication is to be performed using the TA value included in the Cell Switch Command, without using the TA value that is based on the second identification information.

9. The terminal apparatus according to claim 8, wherein
the terminal apparatus receives the first identification information and the second identification information through RRC Reconfiguration.

10. The terminal apparatus according to claim 8, wherein
the control method further comprises, in a case where third identification information is received through the Cell Switch Command, performing the cell switching using a cell specified by third identification information as the switch destination cell.

11. A control method executed by a terminal apparatus compliant with a 3rd Generation Partnership Project (3GPP (registered trademark)) cellular communication standard, the method comprising:
receiving first identification information and second identification information before receiving a Cell Switch Command for instructing switching of a cell to which the terminal apparatus is connected, the first identification information identifying setting information of a cell that is a candidate cell in cell switching, and the second identification information being related to a Timing Advance value (TA value) used for the candidate cell; and
in a case where the cell switching is to be performed with use of the first identification information based on reception of the Cell Switch Command, determining, based on information included in the Cell Switch Command, whether to perform uplink communication using a TA value that is based on the second identification information related to a switch destination cell,
in a case where a value indicating a TA value is included in the Cell Switch Command, the terminal apparatus determines that uplink communication is to be performed using the TA value included in the Cell Switch Command, without using the TA value that is based on the second identification information.
